(19) United States
(12) Patent Application Publication
(10) Pub. No.: US 2014/0188811 A1
(43) Pub. Date: Jul. 3, 2014

(54) SYSTEMS AND METHODS FOR PROVIDING CONTINUOUS FILE PROTECTION AT BLOCK LEVEL

(71) Applicants: Qing K. Yang, Saunderstown, RI (US); Jin Ren, Acton, MA (US)

(72) Inventors: Qing K. Yang, Saunderstown, RI (US); Jin Ren, Acton, MA (US)

(73) Assignee: Board of Governors for Higher Education, State of Rhode Island and Providence Plantations, Providence, RI (US)

(21) Appl. No.: 14/188,174

(22) Filed: Feb. 24, 2014

Related U.S. Application Data
(63) Continuation of application No. 13/114,168, filed on May 24, 2011, now abandoned.
Application No. 13/114,168 is a continuation of application No. PCT/US2009/064504, filed on Nov. 16, 2009.
(60) Provisional application No. 61/117,758, filed on Nov. 25, 2008.

(51) Int. Cl. G06F 11/14

(52) U.S. Cl. CPC G06F 11/1412
USPC 707/671

(57) ABSTRACT

A system and method are disclosed for providing continuous file protection in a computer processing system. In accordance with an embodiment, the system includes a configuration module, a filter driver, and a storage module. The configuration module permits a user to elect certain files or folders for protection. The configuration module runs at an application layer without involving the computer processing system's operating system. The filter driver intercepts and splits write input and outputs addressed at protected files or folders. The storage module is also run without involving the computer processing system's operating system. The storage module is for performing functions including data logging, version managements, and data recovery.

### PRIORITY

The present application is a continuation application of PCT/US2009/064504 filed Nov. 16, 2009, which claims priority to U.S. Provisional Patent Application Ser. No. 61/117,758 filed Nov. 25, 2008, the entire disclosure disclosures of which is are hereby incorporated by reference.

### GOVERNMENT SPONSORSHIP

This invention was made with government support under Grant No. 01886 awarded by the National Science Foundation. The U.S. government has certain rights to this invention.

### BACKGROUND

The invention generally relates to data recoverability systems, and relates in particular to continuous data protection systems.

Data recoverability has become increasingly important with the exponential growth of networked information services and continued digitalization. Real world demands for continuous data protection and recovery are ever present because any data loss is not tolerable for many businesses and government organizations. It has been reported that about 40% of data losses are caused by viruses and human errors. See “The Cost of Lost Data” by D. M. Smith, Journal of Contemporary Business Practice, 2003, vol. 6, no. 3. Such data loss may be salvaged by recovering files to previous versions. Unfortunately however, it is also reported that 35% of users never back up their files and 76% of those who do back up their files, do not do it often enough as reported in “Most Computer Users Walk a Digital Tightrope” by Maxtor Corp., at http://www.harrisinteractive.com/news/newsletters/clientnews/Maxtor 2005.pdf, September 2005. Traditional snapshots and incremental backups leave vulnerable openings between consecutive versions of operating systems that are typically separated by long intervals because of performance considerations.

Continuous data protection (CDP) has drawn great interest in the research community recently. In general, CDP may be implemented either at a user/file system level or at a block level. Early data protection systems were implemented at a file system level using file versioning. By keeping different file versions regarding each file change, any file may be recovered to a previous version in case of human errors. Recent research studies implement CDP at block level such as the techniques proposed, for example, in “TRAP-Array: A Disk Array Architecture Providing Timely Recovery to Any Point-in-Time” by Q. Yang, W. Xiao and J. Ren, Proceedings of the 33^{rd} Annual International Symposium on Computer Architecture, June 2006, pp. 289-301; “Architectures for Controller Based CDP” by G. Laden, P. Ta-Shma, E. Yaffe, M. Factor and S. Flenblit, Proc. of the 5^{th} USENIX Conference on File and Storage, San Jose, Calif. February 2007; “Virtual Time Machine Travel Using Continuous Data Protection and Checkpointing” by P. Ta-Shma; G. Laden, M. Ben-Yehuda and M. Factor, ACM SIGOPS Operating Systems Review, January 2008; and “Efficient Logging and Replication Techniques for Comprehensive Data Protection” by M. Lu, S. Lin and T. Chiueh, Proc. of the 24^{th} IEEE Conference on Mass Storage Systems and Technologies (MSST 2007), San Diego, Calif., September 2007. Block level CDP stores logs of changed data blocks so that one can recover data in case of a failure to a previous point in time by tracing back the CDP logs.

Protecting data in a file system is problematic in several ways, as pointed out in “Secure File System Versioning at the Block Level” by J. Wires and M. J. Feeley, ACM SIGOPS Operating Systems Review, June 2007. First, it is difficult for OS vendors to make changes to existing file systems. Second, the complexity of such file versioning leaves it as vulnerable as the rest of the system to bugs and malicious exploit. Third, file versioning incurs non-trivial performance overhead as indicated in “Portable and Efficient Continuous Data Protection for Network File Servers” by N. Zhu and T. Chiueh, Proc. of the 37^{th} Annual IEEE/IFIP International Conference on Dependable Systems and Networks (DSN 07), Edinburgh, UK, June 2007, pp. 687-697. In addition, with the exponential growth of data, the size of metadata is no longer negligible. The paramount storage space needed for file versioning system aggravates this metadata problem even further.

Many existing file versioning systems use file system index nodes (Modes) to manage versioning data making it difficult to do real CDP because the Mode resources are limited. Some systems such as XOSoft Enterprise Rewinder as sold by CA, Inc. of Islandia, N.Y., save every file write operation in a log instead of using Modes to index versioning data. As a result, any recovery operation requires rewinding of the entire log, which is time consuming.

Block level CDP overcomes many of the limitations of file versioning by logging the changes for every data block. Block level CDP also makes it possible to off-load an application's storage transactions and versioning functions to powerful and low cost embedded systems at storage targets that may process a large amount of data efficiently. Unfortunately, block level CDP requires excessive storage space to keep all changed blocks. While there are research efforts trying to minimize storage cost of CDP (see for example, “Peabody: The Time Traveling Disk” by C. B. Morrey III and D. Grunwald, Proc. of IEEE Mass Storage Conference, San Diego, Calif., April 2003; “TRAP-Array: A Disk Array Architecture Providing Timely Recovery to Any Point-in-Time” by Q. Yang, W. Xiao and J. Ren, Proceedings of the 33^{rd} Annual International Symposium on Computer Architecture, June 2006, pp. 289-301; and “Clotho: Transparent Data Versioning at the Block I/O Level” by M. D. Flouris and A. Bilas, 21^{st} IEEE Conference on Mass Storage Systems and Technologies (MSST 2004), Maryland, April 2004, pp. 315-328), it is still possible that many block changes such as the ones in system swap files are logged unnecessarily because of the lack of knowledge of what blocks need to be protected and what blocks do not need to be protected. This is one of the reasons why user level CDP has its merit. Users know best which data is important that should be protected such as financial data, and which data does not need to be protected continuously such as executable programs and Internet downloads etc.

File versioning may be used for storage data recovery or digital information audition. Generally, there are three approaches to keeping the changing history of data. The first approach is from an application level such as version control systems. Examples of such version control systems include: CVS (see “Version Management with CVS”, by P. Cederqvist et al., Network Theory Limited, Bristol, UK, November 2006), RCS (“The Source Code Control System” by M. J. Rochkind, IEEE Trans. Softw. Eng., December 1975, vol.SE-1, no.4, pp. 364-370), PRCS (“PRCS: The Project Revision Control System” by J. MacDonald, P. N. Hilfinger and L. Semenzato, Proc. of the Eighth International Symposium System Configuration Management, Brussels, Belgium, July 1998, pp. 33-45), Aegis (sold by NetIQ Corporation of Seattle Wash.), Subversion (an open source program operated by Tigris.org), and Visual SourceSafe (owned by Microsoft Corporation of Redmond Wash.). These systems have been widely used for source code version management for single and cooperating developers. The CVS server system keeps a complete record of committed versions in a repository and uses delta compression to improve storage efficiency. Clients connect to the server to check out any version and then check in changes. Users need to learn how to use special tools to commit or retrieve old versions. This approach is not transparent to users.

The second approach is file-system-level versioning as studied, for example, in “The Cedar File System” by D. K. Gifford, R. M. Needham and M. D. Schoeder, Communications of the ACM, March 1988, vol. 31, no.3, pp. 288-298; and “Scale and Performance in a Distributed File System” by J. H. Howard, M. L. Kazar, S. G. Menees, D. A. Nicholas, M. Satyanarayanan, R. N. Sidebotham and M. J. West, ACM Transactions on Computer Systems, February 1988, vol. 6, no.1, pp. 51-81. The use of traditional snapshots (which work as versioning) is employed in many systems to recover from failure. See “The Episode File System” by S. Chutani, O. T. Anderson, M. L. Kazar, B. W. Leverett, W. A. Mason, and R. N. Sidebotham, Proc. of the USENIX Winter 1992 Technical Conference, San Francisco, Calif., 1992, pp. 43-60; “Plan 9” by D. Presotto, Proc. of the Workshop on Micro-Kernals and Other Kemal Architectures, Seattle, Wash., April 1992, pp. 31-38; “SnapMirror: File System Based Asynchronous Mirroring for Disaster Recovery” by H. Patterson, S. Manley, M. Federwisch, D. Hitz, S. Kleiman and S. Owara, Proc. of the Conference on File and Storage Technologies (FAST 2002), Monterey, Calif., January 2002, pp. 117-129; “File System Design for an NFS File Server Appliance, by D. Hitz, J. Lau, and M. Malcom, Proc. of the USENIX San Francisco 1994 Winter Conference, Proc. of the USENIX San Francisco, Calif., January 1994; “A Fast File System for UNIX, M. K. Mekusick, W. N. Joy, J. Leffler and R. S. Fabry, ACM Transactions of Computer Systems, August 1984, vol. 2, no.3, pp., 181-197; and “The Design and Implementation of a Log-Structured File System”, by M. Rosenblum and J. K. Ousterhout, ACM Transactions on Computer Systems, February 1992, vol. 10, no.1, pp. 26-52.

Certain systems such as the ZFS system (available at opensolaris.org) perform snapshots very quickly since ZFS uses a copy-on-write transaction model, which already stores both the old and the new data. While disk and volume snapshot recover whole disk or volume, file grain versioning is able to recover individual files thus reducing the recovery time. Another system called Elephant (as disclosed in “Deciding When to Forget in the Elephant File System” by D. J. Santry, M. J. Feeley, N. C. Huthcinson, A. C. Veitch, R. W. Carton and J. Ofar, Proc. of the 17^{th} ACM Symposium on Operating Systems Principles (SOSP), Kaiwah Insland Resort, S.C., December 1999, pp. 110-123) provides four file grain retention policies and seeks to make version creation transparent and automatic.

Another system called EXT3COW (as disclosed in “Ext3cow: A Time-Shifting File System for Regulatory Compliance” by Z. Peterson and R. Burns, ACM Transactions on Storage (TOS), May 2005, vol. 1, no.2, pp. 190-212; and “Verifiable Audit Trails for a Versioning File System by R. Burns, Z. Peterson, G. Ateniese and S. Bono, Proc. of the 2005 ACM Workshop on Storage Security and Survivability, Fairfax, Va., November 2005, pp. 44-50)) also provides file versioning recovery. The EXT3COW system changes only on-disk metadata to make it compatible with EXTI and provides a fine-grained, interactive, and continuous-time interface for file versions and snapshots.

There have also been efforts to keep file versioning independent of file systems. See for example, “Wayback: A User-Level Versioning File System for Linux” by B. Cornell, P. A. Dinda, and F. E. Bustamante, Proc. of the USENIX Annual Technical Conference (FREENIX Track), Boston, Mass., June 2004, pp. 19-28; “Portable and Efficient Continuous Data Protection for Network File Servers” by N. Zhu and T. Chiueh, Proc. of the 37^{th} Annual IEEE/IFIP International Conference on Dependable Systems and Networks (DSN 07), Edinburgh, UK, June 2007, pp. 687-697; and “A Versatile and User-Oriented Versioning File System” by K. K. Muniswamy-Reddy, C. P. Wright, A. Himmer and E. Zadok, Proc. of the Third USENIX Conference on File and Storage Technologies (FAST 2004), San Francisco, Calif., March 2004, pp. 115-128. The Wayback system is based on FUSE (File system in User Space) and creates a new version upon each write. Each file has a shadow undo log file to keep all the changed data automatically. The system of Zhu and Chiueh mentioned above, (“Portable and Efficient Continuous Data Protection for Network File Servers”), compared four user-level CDP schemes: UCDP-O, UCDP-A, UCDP-I and UCDP-K based on its implementation on NFS.

The Versionfs system of Muniswamy-Reddy, Wright, Himmer and Zadok, mentioned above, runs on a stackable file system (see “FiST: A Language for Stackable File Systems” by E. Zadok and J. Nieh, Proc. of the Annual USENIX Technical Conference, San Diego, Calif., June 2000, pp. 55-70) providing user customable storage policies: full mode, compress mode and sparse mode. Similar to Elephant, Versionfs has three retention policies: number, time and space. The main disadvantage of file system versioning is metadata efficiency especially for comprehensive versioning system. Each change to a file or a directory needs one or more new Modes, which exhausts system resources quickly.

Other systems such as CVFS (see “Metadata Efficiency in Versioning File Systems” by C. A. N. Soules, G. R. Goodson, J. D. Strunk and G. R. Ganger, Proc. of the 2^{nd} USENIX Conference on File and Storage Technologies, San Francisco, Calif., March 2003, pp. 43-58) use journal-based metadata to reduce metadata cost in comprehensive versioning file systems. Further systems such as Spiralog (see “Designing a Fast On-Line Backup System for a Log-Structured File System by R. J. Green, A. C. Baird and J. C. Davies, Digital Technology Journal, October 1996, vol. 8, no.2, pp. 32-45) and Plan 9 (see “Plan 9” by D. Presotto, Proc. of the Workshop on Micro-Kernals and Other Kernal Architectures, Seattle, Wash., April 1992, pp. 31-38) use similar log structure to do backup to save space. Such systems however, trade off recovery performance for storage space efficiency because the journal rollback is time consuming and even the performance of current version may be impacted negatively to retrieve or append the journal.

The third approach is at block level independent of upper level file systems and can be off-loaded to storage server. For example, the Venti system (see “Venti: A New Approach to Archival Storage” by S. Quinlan and S. Dorward, Proc. of Conference on File and Storage Technologies (FAST 2002), Monterey, Calif., January 2002, pp. 89-102) is a network archive storage system that uses hash values to find and coalesce duplicated blocks to reduce the consumption of disk storage space.

Some commercial products such as TimeFinder (sold by EMC Corporation of Westborough, Mass.), TotalStorage (sold by International Business Machines of Armonk, N.Y.), and HDS (sold by Hitachi Corporation of Hitachi City, Japan) do snapshot at block level to provide recoverability. Such systems all claim certain optimization to reduce the performance penalty of snapshots. The Clotho system (see “Clotho: Transparent Data Versioning at the Block I/O Level” by M. D. Flouris and A. Bilas, 21^{st} IEEE Conference on Mass Storage Systems and Technologies (MSST 2004), Maryland, April 2004, pp. 315-328) uses differential encoding algorithm together with large extents and sub-extents addressing to reduce disk space cost of snapshot.

Another system, the Petal system (see “Petal: Distributed Virtual Disks” by E. K. Lee and C. A. Thekkath, Proc. of the Seventh International Conference on Architectural Support for Programming Languages and Operating Systems (ASPLOS-7), Cambridge, Mass., 1996, pp. 84-92) is a block level distributed storage system that supports multiple clients. These approaches provide limited versioning with vulnerable intervals between versions. Many studies regarding Continuous Data Protection (CDP) as discussed above have targeted providing fine recovery granularity for storage devices and improving storage efficiency but still need huge storage space to store versioning data. One system named VDisk (“Secure File System Versioning at the Block Level” by J. Wires and M. J. Feeley, ACM SIGOPS Operating Systems Review, June 2007) secures versioning data by logging it to a read-only disk through driver and interprets versioning data by a user level tool. CDP products from NSI (sold by Double-Take Software, Inc. of Southborough, Mass.), XOSoft (sold by CA, Inc. of Islandia, N.Y.), and Veritas (sold by Symantec Corporation of Mountain View, Calif.) provide file-grain protection, file operations are captured at file system level and saved in log. Users however, need to undo the log to recover data, which is usually time-consuming.

It is clear that both file system versioning and block level CDP have their merits but also each has certain limitations as discussed above. There is a need therefore, for a system and method for providing data recoverability that avoids the above limitations.

### SUMMARY

The present invention provides a system and method for providing continuous file protection in a computer processing system. In accordance with an embodiment, the system includes a configuration module, a filter driver, and a storage module. The configuration module permits a user to elect certain files or folders for protection. The configuration module runs at an application layer without involving the computer processing system's operating system. The filter driver intercepts and splits write input and outputs addressed at protected files or folders. The storage module is also run without involving the computer processing system's operating system. The storage module is for performing functions including data logging, version managements, and data recovery.

In accordance with another embodiment, the invention provides a method of providing continuous file protection in a computer processing system that includes the steps of: providing a configuration module that permits a user to elect certain files or folders for protection, wherein said configuration module runs at an application layer without involving the computer processing system's operating system; intercepting and splitting write inputs and outputs addressed at protected files or folders with a filter driver; and performing functions including data logging, version managements, and data recovery using a storage module that is run without involving the computer processing system's operating system.

### BRIEF DESCRIPTION OF THE DRAWINGS

The following description may be further understood with reference to the accompanying drawings in which:

FIG. 1 shows an illustrative diagrammatic view of a portion of a system in accordance with an embodiment of the invention;

FIG. 2 shows an illustrative diagrammatic view of a CFP Storage Module of the system of FIG. 1 wherein multiple files are selected to be protected;

FIG. 3 shows an illustrative diagrammatic view of data organization of whitelist and blacklist data for use in a system of FIG. 1;

FIG. 4 shows an illustrative diagrammatic view of CFP metadata and data organization in a system of FIG. 1;

FIG. 5 shows an illustrative diagrammatic functional view of a I/O requests processing in a system in accordance with an embodiment of the invention;

FIG. 6 shows an illustrative program for performing the I/O requests processing of FIG. 5;

FIG. 7 shows an illustrative graphical representation of a comparison of performance of a system of the invention with existing file versioning systems;

FIG. 8 shows an illustrative graphical representation of the number of transactions involved for different file sizes a Postmark result of CFP and XOSoft for a system of the invention and for prior art systems;

FIG. 9 shows an illustrative graphical representation of request size versus transfer rate for a system of the invention and for prior art systems;

FIG. 10 shows an illustrative graphical representation of request size versus CPU utilization for a system of the invention and for prior art systems;

FIG. 11 shows an illustrative graphical representation of request size versus transfer rate for another system of the invention and for prior art systems;

FIG. 12 shows an illustrative graphical representation of request size versus CPU utilization for another system of the invention and for prior art systems;

FIG. 13 shows an illustrative graphical representation of a number of users versus response time for a system of the invention and for prior art systems;

FIG. 14 shows an illustrative graphical representation of recover granularity versus metatdata for a system of the invention and for prior art systems;

FIG. 15 shows an illustrative graphical representation of a write data size versus space for a system of the invention and for prior art systems; and

FIG. 16 shows an illustrative graphical representation of write data size versus time for a system of the invention and for prior art systems.

The drawings are shown for illustrative purposes.

### DETAILED DESCRIPTION

This invention proposes a new approach overcoming the limitations of and taking advantages of both file system versioning and block level CDP. A principal idea of the design of various embodiments is to separate CDP systems into three independent modules. In accordance with various embodiments, the new design provides continuous file protection and recovery (CFP).

An objective is to provide a comprehensive data protection mechanism that is capable of protecting and recovering specific files to any point-in-time with minimum addition to the operating system (OS) kernel. CFP consists of three main software modules. The first module is a configuration module allowing a user to set up data protection policies and elect which files to protect etc. This module runs at application layer keeping OS untouched. The second module is a thin filter driver inside the kernel that only intercepts and splits write input/output (I/O)s addressed at protected files or folders. The third module is again outside of OS running at a storage target as an Internet device to perform functions such as data logging, version managements, and data recovery. While creation, maintenance, and recovery of versions of data are all done at block level, the unit of data protection and recovery can be individual files, directories, or volumes. CFP takes advantage, therefore, of both block level CDP and file/user level CDP. Experiments have shown that the new CFP implementation compares favorably to existing CDP solutions.

In short, the first module that runs at application level allows users to configure data protection policies such as elect which files or folders to protect and the location of the CFP storage etc. This module is used to initialize the system and will not consume system resources such as CPU and memory at run time; the module therefore, will not impact application performance.

The second module is a very light weight filter driver that is simple and small. The only function that this filter driver performs is to split and mirror all write I/Os that are addressed to protected files/volumes. One write I/O goes to the primary storage and the other goes to the Windows iSCSI initiator that in turn sends the write I/O to the CFP storage on the Internet with an IP address defined at configuration stage. With this thin layer driver and limited functionality, the performance impact of CFP on applications may be kept minimal in addition to providing easy verification of its correctness.

The third module, the CFP storage module, is also a Windows application program that is implemented as an iSCSI target. This CFP storage module takes all write I/Os from the iSCSI initiator and performs data logging, version management, metadata management, and recovery functions. Since the iSCSI target uses separate computing resources and is independent of and geographically remote from application servers for disaster recovery purposes, the performance of application servers will not be impacted by version creation, maintenance, and recovery functions.

A prototype CFP on Windows 2003 has been successfully developed and tested. The prototype implementation may be easily installed on existing Windows systems. Although the CFP log is implemented at block level CDP storage, users may select individual files, directory, or volumes to be protected continuously. The filter driver mirrors only the write I/Os addressed to the protected files to the CFP storage. In addition, the user designates an iSCSI target as the CFP storage using an IP address that may be located anywhere on the Internet. Recovery experiments have been carried out to show that the prototype implementation can recover user files to any point in time very quickly. Instead of recovering entire volumes in pure block level CDP, CFP allows users to select individual files, directories, or volumes to protect and recover.

To evaluate the space efficiency and the possible performance impact on applications at run time, performance measurements have been carried out using standard benchmarks such as lometers, Postmarks, and LoadSim. Numerical results show that the recovery time of CFP is orders of magnitude lower than a typical commercial product and does not increase significantly as versioning data becomes large. In terms of run-time application performance, CFP is two times faster than commercial file system CDP products. At the same time, it is at least as data space efficient than block level CDPs and at least as metadata space efficient than existing versioning systems.

Certain primary contributions in systems in accordance with various embodiments are the following: First, a new continuous data protection mechanism is provided that is tailored to each user's interest. The new mechanism allows users to determine what specific files or folders to protect. Second, a new hybrid approach to data protection is provided that takes advantage of both file system level design and block level design. The design has minimum performance impact while keeping the storage overhead small. Third, a prototype implementation of the design has been implemented on a Windows Operating System platform (as sold by Microsoft Corporation of Redmond, Wash.). Extensive testing has also been performed to show the robustness of our prototype. Fourth, a comprehensive performance measurement and evaluation has been conducted as compared with existing commercial products that provides continuous data protection at file level, and existing file versioning systems.

In accordance with an embodiment, a system of the invention is designed with the following objectives in mind: 1) Users determine what data to protect, 2) Minimum performance impact on applications, 3) Space efficiency in keeping versioning logs, 4) Metadata efficiency and, 5) Fast recovery of data to any previous point-in-time. These goals are achieved in an embodiment using the combination of a file system level driver and a block level iSCSI target.

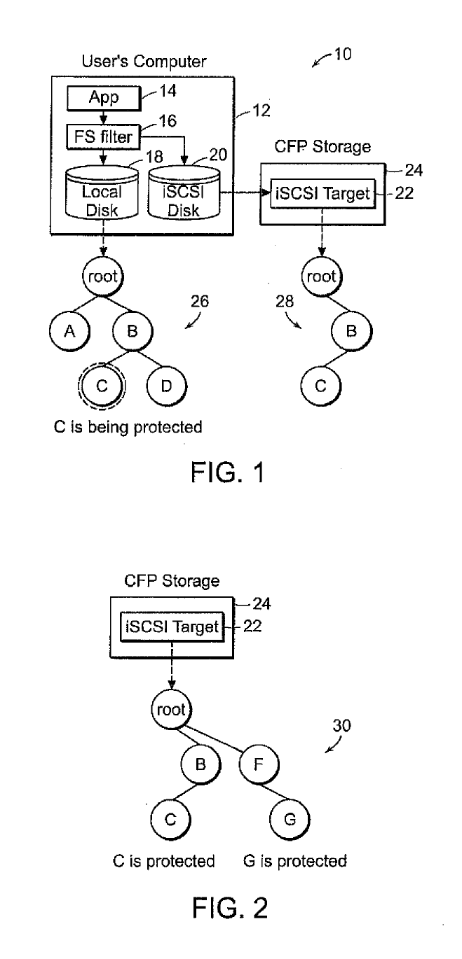

As mentioned above, CFP consists of three parts: a user configuration tool, a file system filter driver, and a block level CFP storage. FIG. 1 shows at 10 an example of a CFP implementation of a system in accordance with an embodiment. The system includes a user's computer 12 that includes a user configuration tool application program 14, a file system filter 16, a local disk 18 and an iSCSI disk 20, which is in communication with a iSCSI target of within a CFP storage module 24. The user configuration tool is a simple application program that allows a user to select a set of files or directories to be protected and setup other parameters of the CFP storage server 24.

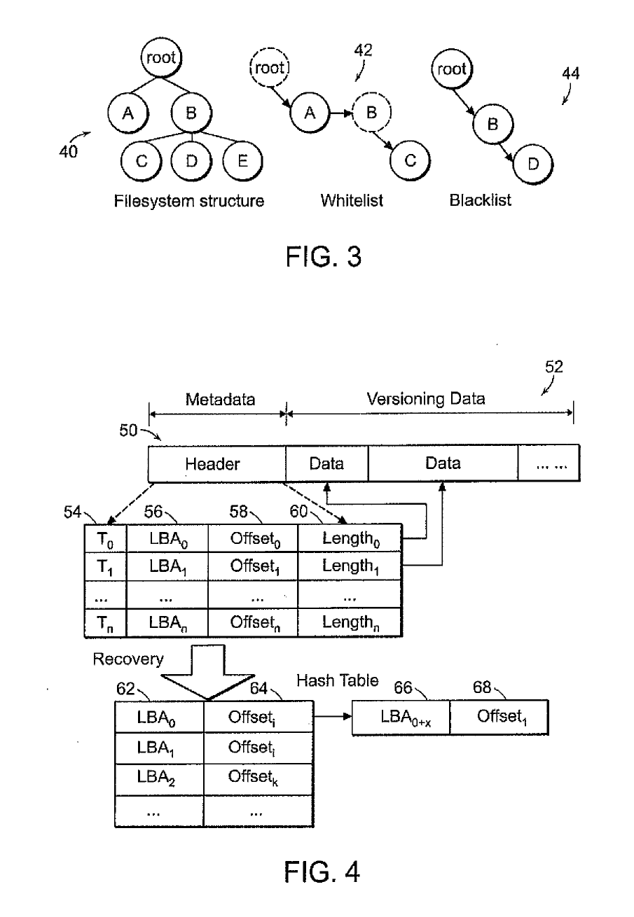

For example, as shown at 26 in FIG. 1, a user selects file C to protect using the configuration tool 12. As a result of such a selection, the direct parent directory B and root are created and file C is copied to the CFP storage (as shown at 28) with the same path. After the user finishes the configuration, a list of files to be protected, and their associated directory roots are formed as shown at 30 in FIG. 2, and the configuration program closes.

The file system filter driver 16 is a very simple and thin driver. At run time, it intercepts and mirrors write I/Os to the CFP storage. Again, with reference to FIG. 1, any write request to file C on the local machine will be intercepted and forwarded to the iSCSI disk, which appears to file system as a hard disk drive. Suppose the original write request is write (“\\localdisk\\root\\B\\C”, buffer, offset, length). The duplicated write request will be write (“\\iSCSldisk\\root\B\\C”, buffer, offset, length). In this example, only changes to file C will be replicated to iSCSI disk which forwards the write request to CFP storage.

The CFP storage module 24 is embedded in a standard iSCSI target 22 that has been developed as a Windows application program. The main function of the CFP storage is to create, maintain, manage, and recover data. It stores every write request at block level in a versioning log, manages the log and metadata, and recovers data to a previous version in case of failure. Block level versioning is metadata efficient and can offload host CPU and other computing resources. If the CFP storage is located geographically remote from the application server, user can recover data even the application server is damaged in case of disasters. Users may tune the recovery time point through the interactive GUI of iSCSI target. The recovery volume is mounted as a separate volume on users' computer to provide a quick view of history data. It is not necessary to roll back whole volume or disk for CFP, but rather only required files are recovered.

Since CFP is a block level CDP solution, file consistency could be a potential problem. Unless the file is protected by file open-close granularity, block level CDP has the same level of consistency as file system level CDP solution. Modem journal file systems are able to recover a file to a consistency point after crash. So, after CFP server recovers data to certain recovery point, the recovery volume is able to get to a consistency point with the help of file system recovery tools. Neither CFP nor other file system level CDP systems are able to guarantee application consistency.

For example, an effort to recover a file to a point that is in the middle of updating its data, could render that file meaningless to the application. CFP provides the ability to let the user turn effectively the clock back and forth quickly to find the appropriate point.

The CFP kernel module is designed as a very thin driver with minimum performance impact on the host machine. Its major function is to capture and forward write requests to the storage server. CFP is a file-oriented data recovery system that permits users to specify files or directories to be protected. Flow to get file information has always been a problem for block level CDP. The file system semantics related to block level data is only available at the file system level, which can only be captured by a file system filter driver. That is why we need to develop a kernel module to work at the file system level. The first design issue for this filter driver is to find out what requests need to be captured. Obviously, requests that change disk data need to be captured. Other than write requests, file open and close events also need to be monitored because this decides the lifetime of in-memory data structure associated with each file. Table I shows file system level requests that are handled in a current prototype implementation of CFP.

TABLE 1

IRP_MJ_CREATE
IRP_MJ_CLOSE
IRP_MJ_WRITE
IRP_MJ_SET_INFORMATION
IRP_MJ_SET_VOLUME_INFORMATION
IRP_MJ_SET_EA

A major task of the kernel module is to interpret write requests based on the file name of each request. The driver has two choices for each write request: to replicate or not to replicate. To make such choices, the kernel module maintains a whitelist for files that need to be protected, and a blacklist for files that do not need to be protected. The whitelist and blacklist are setup by users at the application level at configuration stage. Each entry stores the name string of a file or a directory. The general rule is to look-up the files in two lists to find the longest matched string to decide how to respond to a request. For example in FIG. 1, ifpath “\\root\\B” is in the blacklist and path “\\root\\B\\C” is in the whitelist, the policy for C is to replicate because a longer string is found in the whitelist. The default policy is not to replicate the request so “\\root” goes to blacklist during initialization.

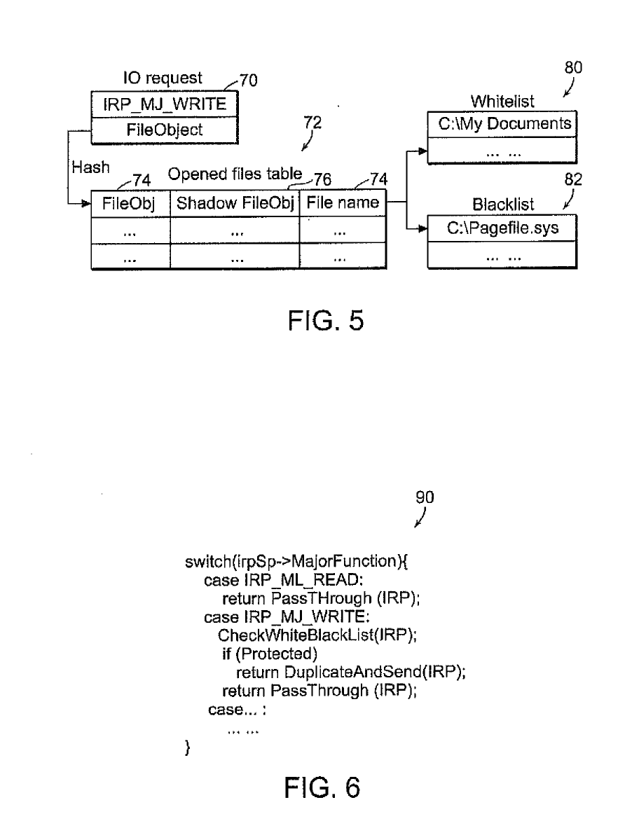

It is desired to design a string matching algorithm to process the whitelist and blacklist lists quickly and efficiently. If the string list is organized in a flat data structure, the complexity to search a string is O(n) which may cause scalability problem. The names of files and folders are structured data making it reasonable to store them in the same way as in the file system. A layered structure has been designed to store the whitelist and blacklist lists as shown in FIG. 3, which shows a file-system structure at 40, a whitelist at 42 and a blacklist at 44. The parent node has a pointer to the children list, which stores all entries of the same level. The complexity of searching this layered structure is O[xlogₓ⁽ⁿ⁾)] where x is the average number of files in each folder. In FIG. 3, “\\root\\A” and “\\root\\B\\C” are protected while “\\root\\B” and “\\root\\B\\D” are not protected. A dashed line circle represents a node that is not really in the list, but just a link node to maintain layered structure. So, “\\root” and “\\root\\B” are not actually in whitelist in FIG. 3. Table 2 below describes several cases and their corresponding decisions by the kernel module.

TABLE 2

| File | whitelist | blacklist | Decision |
|---|---|---|---|
| \root\A | \root\A | \root | Replicate |
| \root\B | Null | \root\B | Bypass |
| \root\B\C | \root\B\C | \root\B | Replicate |
| \root\B\D | Null | \root\B\D | Bypass |
| \root\B\E | Null | \root\B | Bypass |

This layered structure reduces much computational overhead of string matching. The performance of string matching however, is still noticeable for each layer. For instance, before we can make decision for “\\root\\B\\E” by the result returned from blacklist, we need to search it in the whitelist and compare it with all files and folders under “\\root\\B”. If B has many children other than C in the whitelist, all of them need to be compared to make sure the target file name does not exist in the whitelist. This kind of overhead could affect CFP's performance as the sizes of the whitelist and blacklist increase.

To solve this problem, we build a Bloom filter (as disclosed in “Space/Time Trade-Offs in Hash Coding with Allowable Errors” by B. H. Bloom, Communications of the ACM, July 1970, vol. 13, no.7, pp. 422-426) for each layer to make a quick decision whether the target file name does not exist in a layer. The Bloom filter was formulated by B. H. Bloom in 1970 and has been widely used for anti-spam, web caching, and P2P content searching. Querying in Bloom filters is independent of the number of strings in its database and thus solves the scalability problem of the whitelist and blacklist. Given a set of strings of n members, a Bloom filter defines k hash functions, each of which maps a key string to one position in an m bits array. Given a query string, The Bloom filter gets k positions using k hash functions. If any of these positions is 0, this string is not in the set. If all the positions are 1, this string is said to belong to this set for a certain probability. The false positive f is given by:

$$f \approx {( 1 - {e}^{\frac{- nk}{m}} )}^{k}$$

For example, using 100 for n which we assume to be the average number of files and sub-directories within a directory, 2048 for m, and 5 for k, the false probability is less than 0.0005 which is very small. To handle false positives of a Bloom filter, a deterministic string comparison is performed after a match is found by the Bloom filter. Another problem is member deleting from a Bloom filter vector; to address this, we simply rebuild the array upon any member deletion provided that this is not a frequent operation. And the set of keys is limited because the number of files and folders in each layer is limited by the file system.

The last optimization of the CFP driver is a hash table to remember the mapping between file object and file name. It is costly and unsafe to get the file name for the request in the kernel driver, which makes it infeasible to inquiry file name for each request. In fact, the file is always operated by the file object handle after it is opened and the handle will not change until the file is closed. Instead of trying to get the file name by system call for each request, the CFP driver stores the file name with a corresponding handle in a hash table upon file open. Afterward, we can get file name directly from this table without much performance degradation. The hash table resides in memory, and the entry is released when the corresponding file is closed.

The CFP server module is developed based on an iSCSI target. The iSCSI protocol is a network storage protocol that enables the user to access remote storage as a local hard disk. The write requests that the CFP server receives are block level requests that only contain LBA, length, and data. Though CFP server knows nothing about file information associated with these requests, it actually only stores user selected files with the help of CFP kernel module that works on host side. CFP server is designed to have two disks: a primary disk for latest data and a secondary disk for versioning data. The primary disk is synchronized with the host when users specify which file to protect.

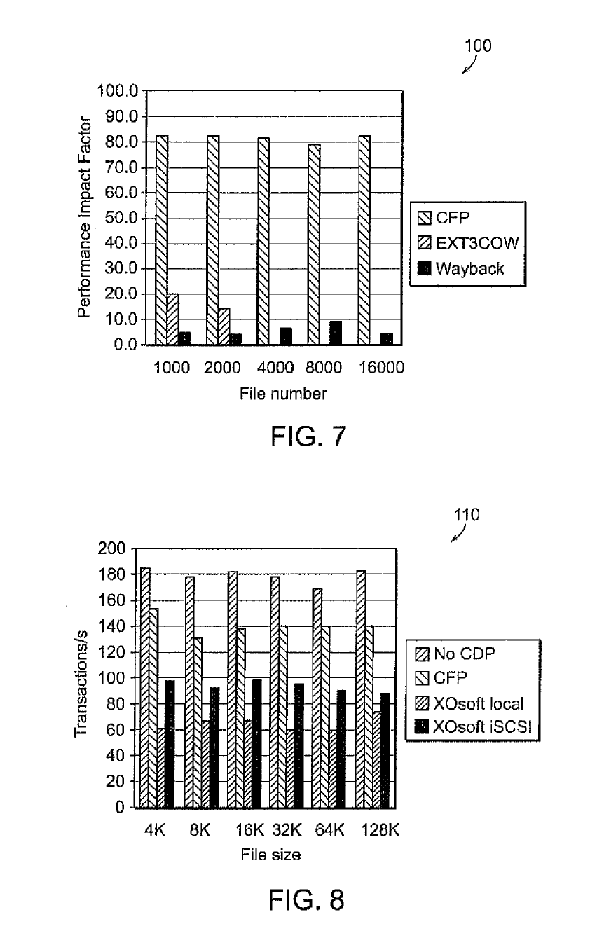

For example in FIG. 1, “\\root\\B\\C” will be copied to the primary disk as well as all of its parents. Parent's directories will be created if they do not exist in the primary disk. As a continuous data protection application that stores every changed block for recovery purpose, the CFP server is able to handle ever increasing versioning data by efficient data placement and metadata organization. Traditional snapshot and incremental backup manage data by large blocks to reduce performance cost and to save metadata space. Data space waste is not a big problem for snapshot and incremental backup because each large block is likely to be fully written within backup time interval. But large block size may cause serious space waste for the CDP application since each block is more likely to be partially used. CFP leverages a write-once log to reduce performance cost while saving both metadata and data space. CFP splits secondary disk into metadata area and data area. As shown in FIG. 4, metadata area stores information for each write and data area stores actual data.

In particular, FIG. 4 shows that the data is organized as including metadata 50 as well as versioning data 52. The metadata 50 provides a header that includes, for each time (T) 54, a local block address (LBA) 56, an offset 58 and a length 60. This requires space that is much smaller compared to most file system versioning systems that use Mode for each change. The Length in each entry is variable so each write can finish by one disk write operation instead of multiple disk read/write access. CFP is file-oriented not only for data backup, but also for data recovery. For file recovery, users mount recovery volume to view old versions of files and copy them to original location. CFP does not need to roll back the primary disk but provides a versioning hash table for every changed LBA. The table is built after processing metadata area to find all entries with time stamps that are later than the recovery point. Each entry of the versioning table links to the old data that has been changed after the recovery point. When the user mounts the recovery volume, the CFP server is able to get the desired files by using the hash table. In particular and as also shown in FIG. 4, for each LBA 62, an associated offset 64 is applied providing an adjusted LBA as shown at 66 to provide the offset as shown at 68.

The CFP file system driver was developed using Microsoft's Installable File System Kit (as sold by Microsoft Corporation of Redmond, Wash.). It is a kernel driver layered above a mounted logical volume device object managed by a file system driver. Any requests to that volume will go through the filter and get processed if they are write requests. A whitelist and a blacklist are maintained to remember files and directories that user wants to protect or not to protect. A user may use the combination of blacklist and whitelist to reduce the number of total items in these two lists. For example, a user may put a directory in white list and put a few temporary files within that directory in the blacklist to protect all other files within that directory. The purpose of doing this is to lower the performance overhead of comparing strings for each request.

When a user decides to protect a single file, the file is copied to an iSCSI disk and its name is added to the whitelist. If its parent directory does not exist in iSCSI disk, the initialization program will create all the parent directories. Then the filter driver starts comparing the file name for each write request such as write data, change file attributes, or delete file. If the target file name is in the whitelist, the request will be replicated and forwarded to iSCSI disk with slightly changing the device name from “\\localdisk” to “\\iSCSIdisk”. For the file rename operation, more must be done because it changes the target file name. If C is renamed as E, we update the corresponding record in the whitelist to “\\rootl\BI\E” directly. If C's parent directory B is renamed as F, although B is not specified to be protected by user, we still need to find all the records in the whitelist and blacklist whose path contain the string “\\rootl\BII” and replace them with “\\rootlIFII”.

To protect a directory is similar to protecting a file. The initialization program first creates that directory and all parent directories, and then copies all existing files and directories in that directory to iSCSI disk. The name of that directory is added to the whitelist for further monitoring. Any writes to existing files or directories will be forwarded to iSCSI disk. When a new file is created within this directory, the create operation will be duplicated to iSCSI disk and a new file will also be created in iSCSI disk. The new file will be protected automatically because its file name contains the same string as its parent directory. When a file is deleted in the local disk, the same file in iSCSI disk will also be deleted. Compared with existing file system versioning systems, we do not need to remember any versioning information at file system level because versioning and recovery is done at block level. In other words, we do not waste file system metadata or pollute file system name space. Users can get the deleted file by mounting the recovery volume of the time point before the file was deleted.

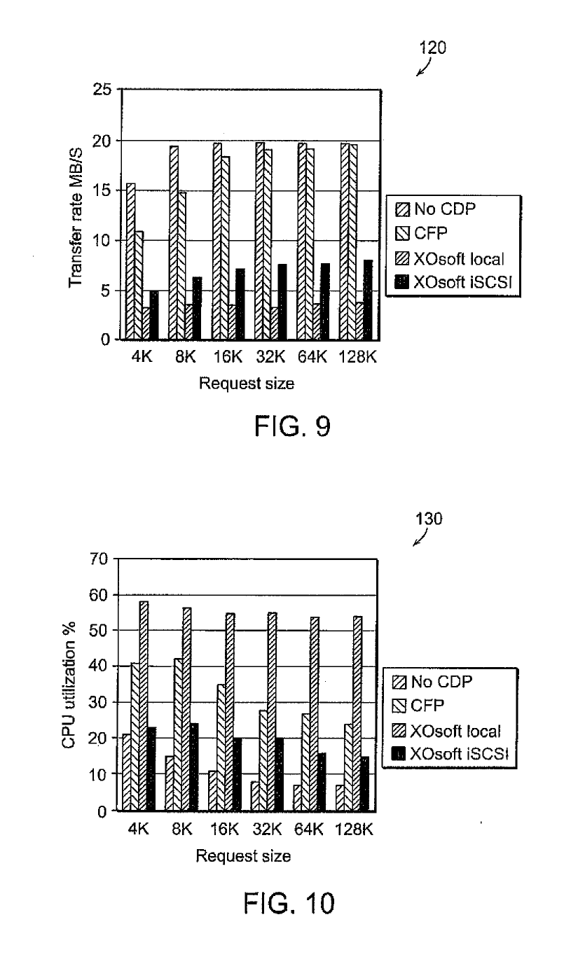

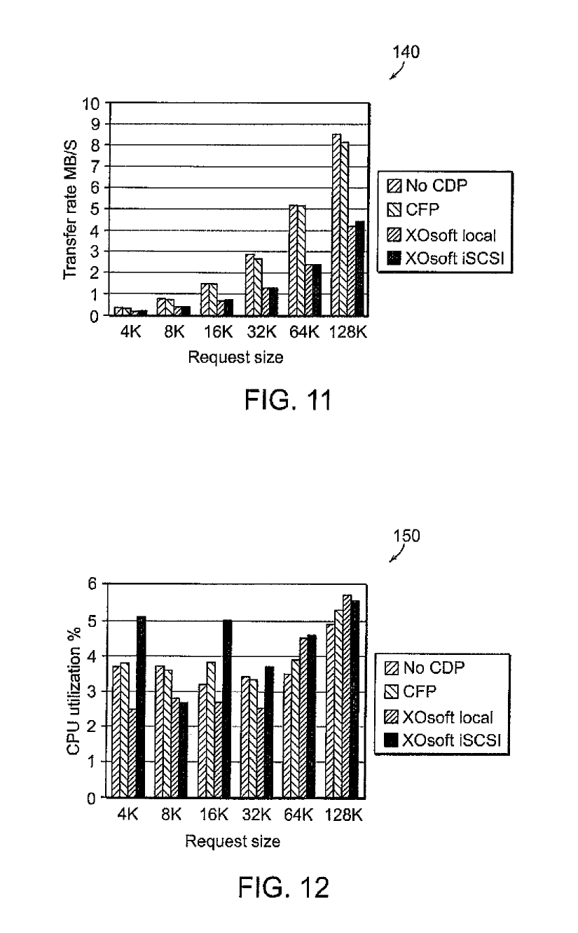

FIG. 5 shows the I/O requests processing work flow and FIG. 6 shows the related data structure. The filter driver maintains a hash table of all opened files to remember the corresponding file name of each file object. This hash table avoids inquiring file name for every I/O request because it is costly and risky to use system call to get file name. As shown in FIG. 5, an I/O request 70 (such as IRP_MJ_WRITE) causes an associated file object to be processed via a hash function in an open files table 72, which includes a file object field 74, a shadow file object field 76 and a file name 78. The file name 78 is then written to either whitelist 80 or blacklist 82 as shown. Each item of the hash table has a shadow file object field that points to a corresponding file in the iSCSI disk. If a file is being protected, its shadow file object is initialized the first time when there is a write request to this file. The filter driver first examines the opcode of each 10 request and bypasses any read request. For a write request, the filter driver further compares its file name with whitelist and blacklist to decide whether to bypass or forward it to CFP storage server. As shown at 90 in FIG. 6, this may be implemented using a routine that executes a “return PassThrough (IRP)” for each IRP_MJ_READ. For each IRP_MJ_WRITE, the system checks the whitelist and the item is protected, the routine returns a “DuplicateAndSend(IRP)” prior to executing the “return PassThrough (IRP)”.

While it is clear that the hybrid approach has superb advantages over pure file system versioning and block level CDP, a quantitative evaluation of its performance and cost as compared with existing approaches was developed. The below discussion presents a performance evaluation of CFP using standard benchmarks such as Postmark (as sold by NetApp Corporation of Sunneyvale, Calif.), lometer (available at iometer.org), LoadSim (sold by Microsoft Corporation of Redmond, Wash.) and Harvard Traces (see “Passive nfs tracing of email and research workloads by D. Ellard, J. Ledlie, P. Malkani and M. Seltzer, 2^{nd} USENIX Conference on File and Storage Technologies (FAST 2003), San Francisco, Calif. March 2003, pp. 203-216).

There are many existing file protection solutions. The ones that are closest and most similar to CFP in terms of functionality, objective, and data protection capabilities were chosen. For example, EXT3COW (see “Ext3cow: A Time-Shifting File System for Regulatory Compliance” by Z. Peterson and R. Burns, ACM Transactions on Storage (TOS), May 2005, vol. 1, no.2, pp. 190-212) and Wayback (see “Wayback: A User-Level Versioning File System for Linux” by B. Cornell, P. A. Dinda, and F. E. Bustamante, Proc. of the USENIX Annual Technical Conference (FREENIX Track), Boston, Mass., June 2004, pp. 19-28) are two typical file versioning systems in the research community that can protect user files and allow users to recover files to a previous point-in-time in case of failures. There are also commercial products that provide file level data protection. A typical example that is close and similar to CFP in functionality and data protection capabilities is XOSoft Enterprise Rewinder (sold by CA, Inc. of Mountain View, Calif.). The following compares CFP with these three file protection systems.

As mentioned above, one of the design objectives was to tailor the CDP solution to users' interests. From a users' perspective, the first important property of a CDP solution is that it should work in background without negatively impacting application performance. The second important consideration is the space overhead required to store CDP data and additional metadata to implement the data protection solutions. A further important consideration is fast recovery in case of data failures. That is, a small RTO (Recovery Time Objective) is important to users for business continuity. These three important parameters are the main focus of the evaluations and comparisons.

The experimental environment consists of basically two main machines, one host computer and one storage server. They are connected using a NetGear GS 105 GBE switch. All experiments were carried out between the host computer and the storage server. The host computer was a laptop with 1.66 GHz Intel Corel CPU, 2 GB RAM, and a 120 GB SATA disk. The storage server was a desktop computer with 2.8 GHz Intel Pentium4 CPU, 1 GB RAM, a 160 GB SATA drive and an 80 GB SCSI 320 disk. The host is running Windows 2003 Server and Ubuntu Linux while the server is running Windows 2003 only.

First consider the performance impact on user applications of the data protection solutions. To be able to compare with EXT3COW and Wayback that are both Linux file versioning systems, we use Postmark benchmark (as sold by NetApp Corporation of Sunneyvale, Calif.) to evaluate their performance. Postmark and has become an industry standard for server performance evaluations. It randomly manipulates a large number of small files to emulate Internet applications such as mail servers. Postmark measures file system performance in terms of transaction rates by running a series of basic file operations on a specified number of small files. Postmark's code for EXTICOW was changed to do one snapshot after all files are created which will not affect the final transaction speed result and we have confirmed this by inserting sleep time at the same place in the code. It was not possible however, to run Postmark using high workload on EXT3COW but it was possible to run using 10000 transactions, 8 KB requests, and start from a small number of files.

The CFP runs on Windows while EXT3COW and Wayback run on Linux. To provide a fair performance comparison on two different platforms, the transaction speed of each data protection technique was measured and compared with the transaction speed of the original system with no data protection program running. The ratio of transaction speed with data protection program running to the transaction speed with no data protection running was employed on each of their respective operating system. This ratio is defined as performance impact factor.

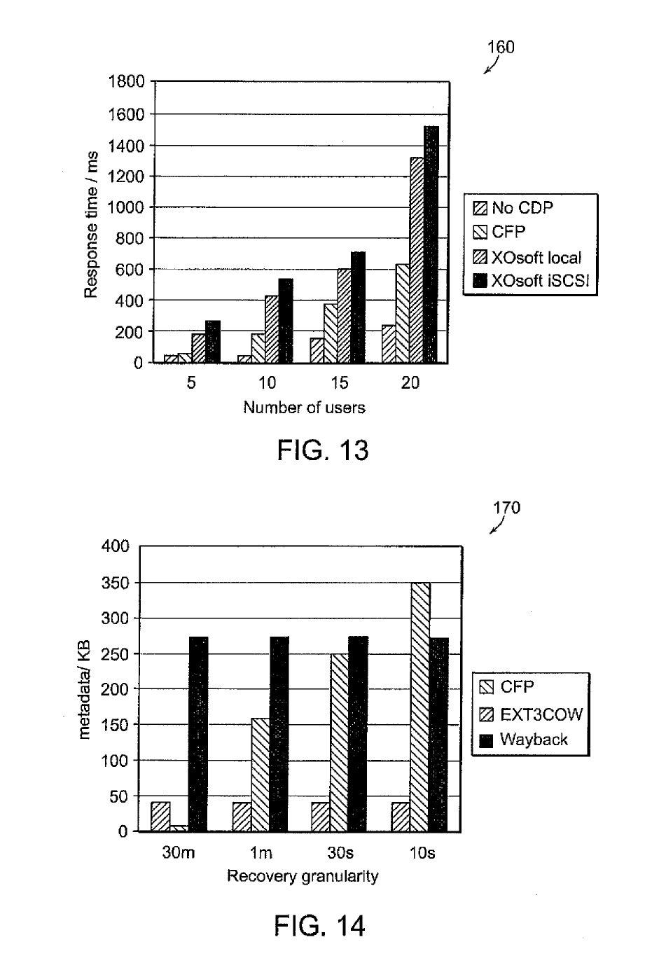

FIG. 7 shows at 100 the measured results in terms of performance impact factors. In this figure, CFP and Wayback are continuous file protection while EXT3COW provides one version in each run. Some bars of EXT3COW are missing because we were not able to run Postmark on it for these numbers of files. CFP's performance is about 80% of original disk while EXTICOW and Wayback are much slower than local disk. The good performance of the CFP can mainly be attributed to the effective design of the thin filter driver that consumes fewer resources in the kernel than EXT3COW and Wayback.

There are constraints and limitations to compare with open source prototypes available in the research community. In order to provide a comprehensive evaluation of our CFP, the 30-day trial version of XOSoft, which is a very popular commercial data protection product for Windows, was used. Because it is a product, we are able to run it using a variety of benchmarks and workload conditions. Furthermore, since both CFP and XOSoft run on Windows platform, performance comparison between them gives more meaningful results. The Postmark was then configured to use 10,000 files and 10,000 transactions. The requests size changes from 4 KB to 128 KB.

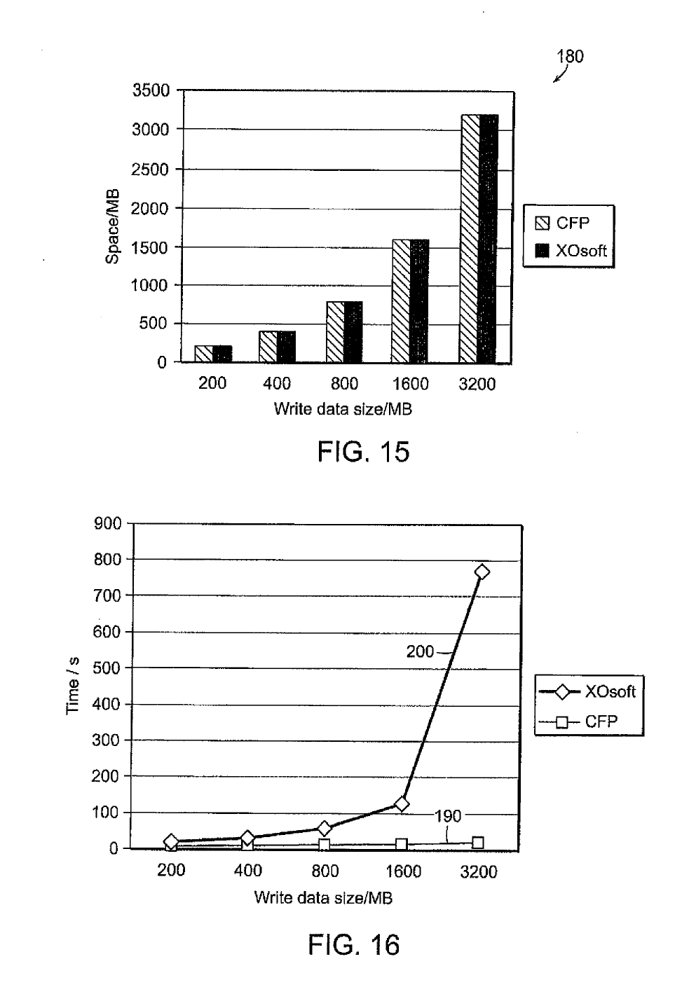

FIG. 8 shows at 110 the measured transaction rate of the two data protection techniques. In FIG. 8, there are 6 groups of bars corresponding to 6 different request sizes. In each group of bars, we draw the transaction rate of no CDP running, transaction rate of CFP, transaction rate of XOSoft on local disk, and transaction rate of XOSoft on remote iSCSI disk. It is observed on FIG. 8 that the CFP can finish 50% more transactions per second than XOSoft. The result clearly shows the performance benefit of using the thin filter driver. It is interesting to observe in FIG. 8 the performance differences between iSCSI disk and local disk. With the same data protection solution, XOSoft for example, the transaction rate with a remote iSCSI disk is higher than local disk because more loads are added upon local disk and other resources on the server for data protection functions. The results further validate our statement at the introduction about the benefit of off-loading data protection functionality to intelligent storage controllers.

Iometer is an I/O subsystem measurement and characterization tool first developed by Intel and now being maintained by open source community (available at Iometer.org). It generates workload simulating multiple applications and evaluates the performance of IO operations and the impact on system. It has a GUI controlling panel and a service as workload generator. The workload can be configured from the GUI, such as changing the request size, distribution, and read/write ratio. For testing disk volume, Iometer creates a large file and sends requests to that file. In our experiment, the file size is 500 MB. The performance of local disk without COP is measured as a baseline reference to observe performance degradation of COP solutions. XOSoft is configured to use local disk as well as iSCSI disk for each test run.

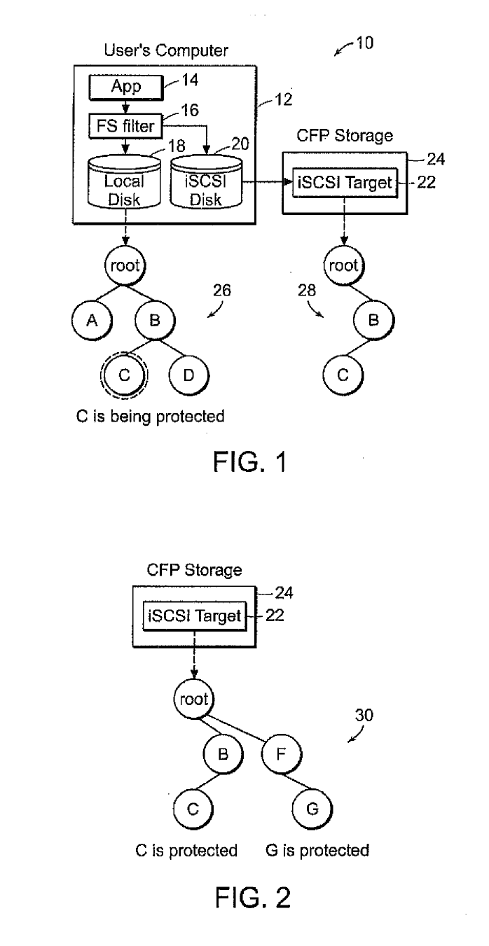

FIG. 9 shows at 120 the throughput result for Iometer of sequential 100% write requests. The CFP is about 2.5 times faster than XOSoft and has little impact on performance compared with local disk without COP. The performance degradation is relatively large for 4 KB and 8 KB request size. This is due to iSCSI packaging and processing delay. For each I/O request, iSCSI needs to process it and add header to it. The proportion of this network delay decreases as the request size increases. As a result, CFP's performance is closer to that of local disk for large request sizes. XOSoft performs better when using remote iSCSI disk as CDP data storage because it reduces I/O workload from the host machine.

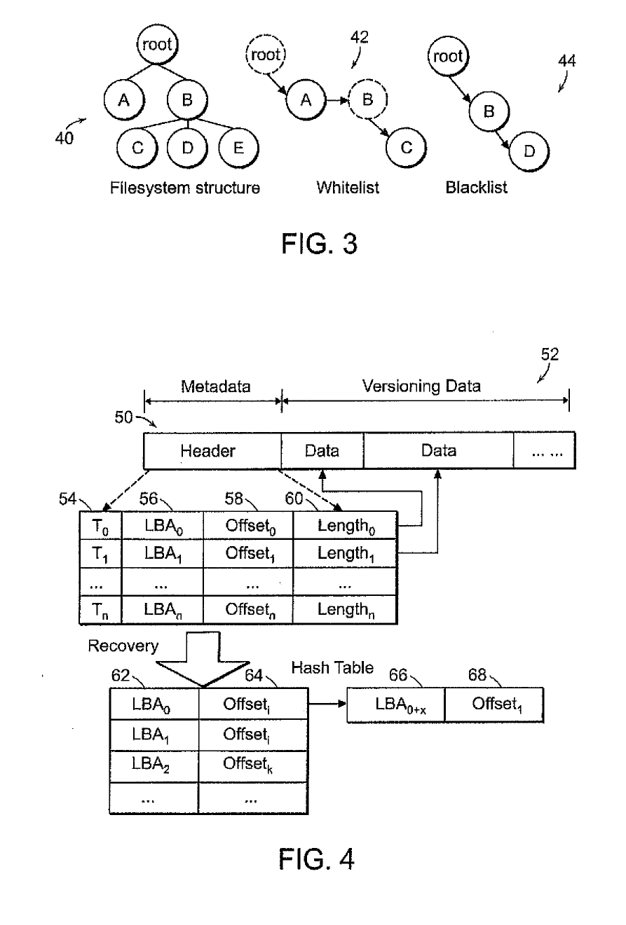

The CPU utilization was also measured while running the benchmark in order to observe the CPU demand of each CDP solution. FIG. 10 shows at 130 the CPU utilization of the two CDP solutions with local disk and remote iSCSI disk, respectively. It can be seen from FIG. 10 that the CPU utilization of XOSoft is over 50% implying high CPU demand when local disk is used for CDP storage. When all versioning functions are processed at the iSCSI storage target, the CPU utilization becomes smaller. The CFP has higher CPU utilization than XOSoft with iSCSI disk. Considering however, that CFP's throughput is more than doubled that of XOSoft, one would expect that its CPU utilization should be at least twice as much as the CPU utilization of XOSoft. It was observed that the CPU utilization of CFP is much less than two times of that of XOSoft. The CFP therefore, takes less system resources than XOSoft does for the same I/O throughput.

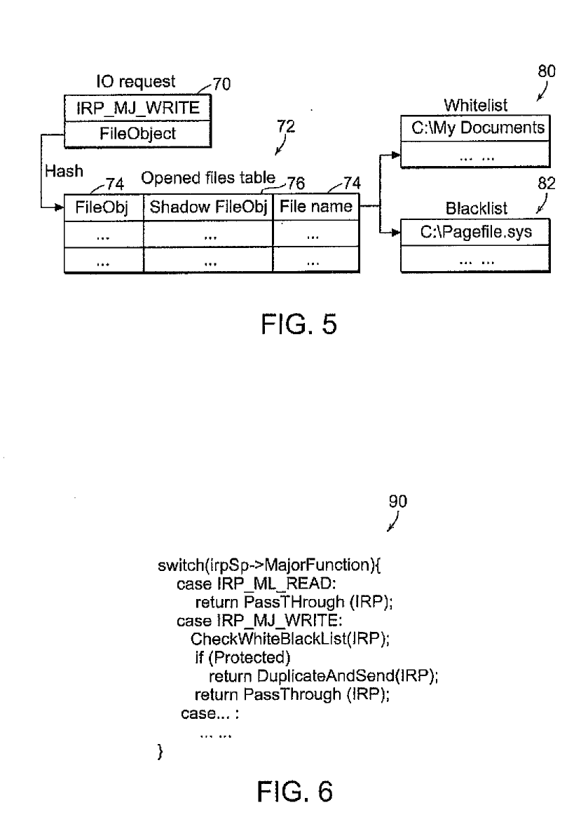

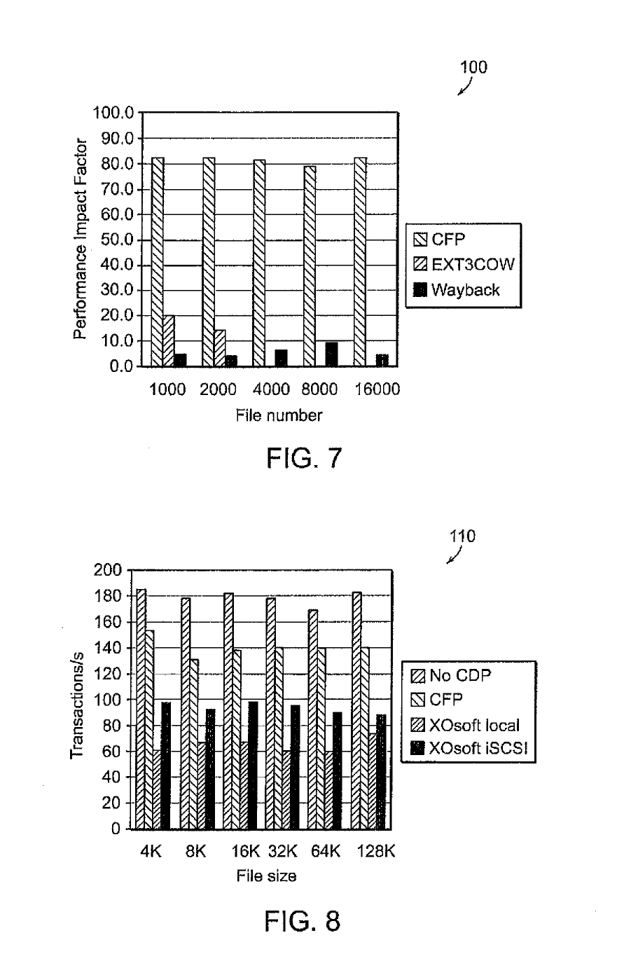

FIGS. 11 and 12 show at 140 and 150 respectively the Iometer results for random I/Os with 33% write requests. Similar to FIGS. 9 and 10, CFP is consistently 2 times faster than XOSoft. The CPU utilization is relatively low here because of lower I/O throughputs.

The next experiment was on Microsoft Exchange Server's Load Simulator 2003, Loadsim. Loadsim is a benchmark to test how a server responds to email workloads. It simulates the delivery of multiple MAN user messaging requests to an Exchange server. In the experiment, Loadsim ran on the Exchange server machine and simulated multiple users ranging from 5 to 20 with each test running for 10 minutes. Request response time seen by each user is the performance parameter. The user response times were measured and the average among them was reported. It was assumed that the entire Exchange Server installation directory is protected including its database files and journal logs.

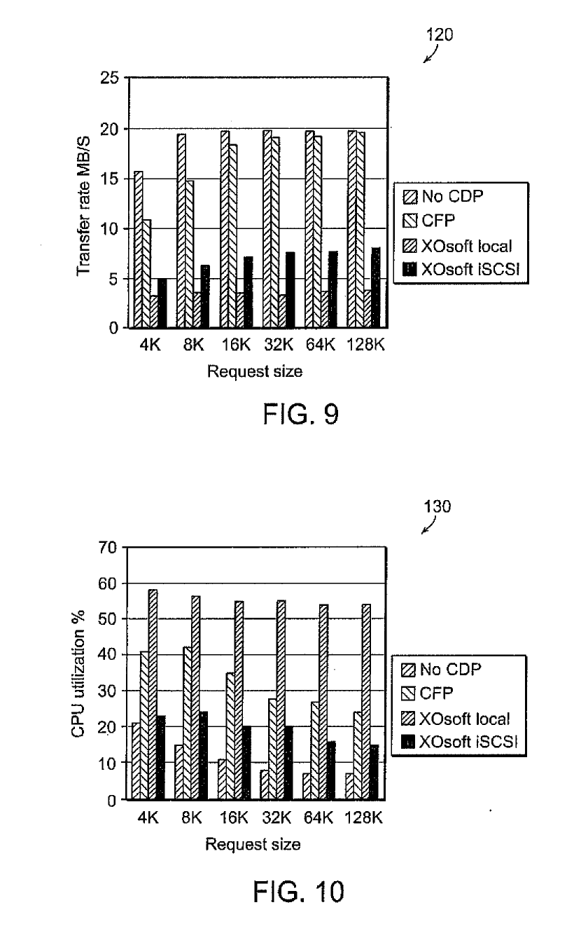

FIG. 13 shows at 160 the average response time of users' messaging requests. It can be seen from this figure that CFP's response time is half of that of XOSoft. The more users we have, the larger the performance difference between CFP and XOSoft. We noticed that the response times of local disk with no CDP program running are constantly smaller than iSCSI storage. The reason is that the CFP file system driver uses synchronous 10 call to forward write requests to iSCSI target. Although iSCSI target can process data asynchronously, the round trip time of a request and response over the network is part of the response time. CFP however, uses very light and thin filter driver with minimum impact to server performance, its response time is much lower than that of XOSoft that does most of the data protection works in file system driver giving rise to higher response time than CFP.

The next experiment was to measure the space overhead of the CDP solutions. There are two parts in the storage overheads: metadata overhead and CDP data itself. To measure the metadata efficiency of the CDP solutions, the Harvard NFS traces (see “Passive nfs tracing of email and research workloads by D. Ellard, J. Ledlie, P. Malkani and M. Seltzer, 2^{nd} USENIX Conference on File and Storage Technologies (FAST 2003), San Francisco, Calif. March 2003, pp. 203-216) was replayed on CFP, EXT3Cow, and Wayback. The traces were collected from a mixture of emails and research workloads of the division of engineering and applied sciences. They were captured using nfsdump for 40 days in 2003. In this test, all write requests generated by trace are forwarded to CFP target directly. Compared with EXTICOW and Wayback, CFP need mirror original file but this also brings additional disasters recoverability. So only metadata that was used to index versioning data was considered in this experiment. The time intervals to do snapshot for EXTICOW and Wayback range from 30 minutes to 10 seconds to represent different recovery granularities.

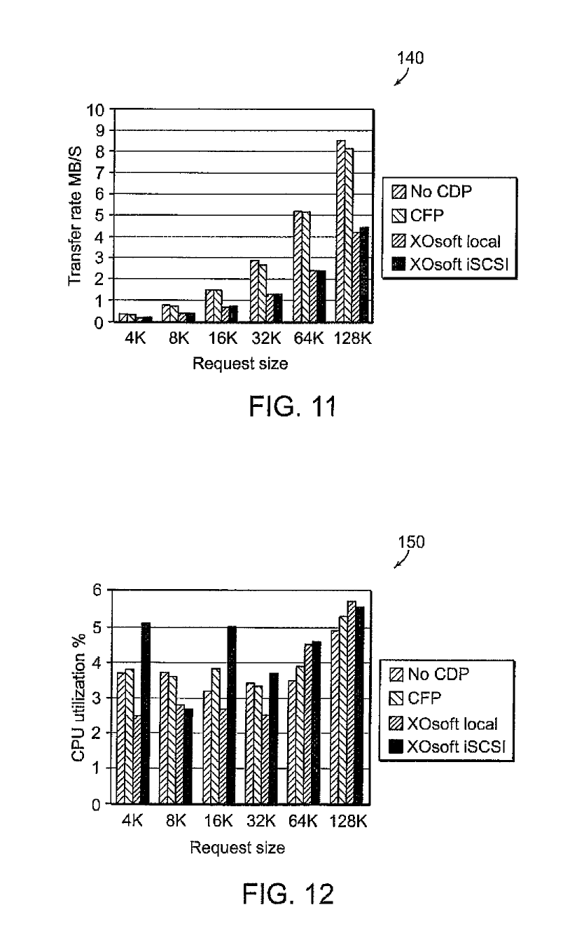

FIG. 14 shows at 170 the measured results of amount of metadata needed for each of the three data protection techniques. It can be seen from FIG. 14 that the metadata size of CFP is significantly smaller than the other two. CFP clearly demonstrates its advantage as a block-level COP in saving metadata space. CFP's versioning is done at block level on storage server and versioning data is organized in a very compact metadata structure as discussed above. Notice that both CPF and Wayback are continuous data protection technique that keeps every write operation. Therefore, their metadata sizes do not change with recovery granularity because both CFP and Wayback store every write request. The total number of write requests in this trace is fixed implying the total metadata size of CFP and Wayback are also fixed. Wayback, however, creates a shadow file for each file, which makes the total number of files doubled. As a result, Wayback uses two times inodes than disk with no protection. EXTICOW also use Mode to index versioning data but new Mode is allocated only when snapshot is taken and write occurs. With the frequency of snapshot increase, more and more inodes are needed to index versioning data as shown in FIG. 14.

CFP is not only metadata efficient compared with file system level versionings, but also data space efficient compared with block level COP. Intuitively, one can easily see the benefit of CFP in terms storing only the data blocks belonging to the files that users want to protect as opposed to storing every block changes including temporary files, swap space, and Internet downloads etc. To have a quantitative sense of how much space saving the CFP can have, consider a few realistic examples listed in Table 3 below.

TABLE 3

| Application | Valuable Files | Temporary Files |
|---|---|---|
| Compile CFP | 2 MB | 205 MB |
| Boot XP | 16 MB | 544 MB |
| Exchange Server | 333 MB | 360 MB |

In the first example, consider our CFP program project stored in a volume. During the design process, source files are changed together with executables. When the project is compiled in VC, data written to the debug folder is about 205 ME. However, write requests to useful file are only within 2 MB. In the second example, during XP boots, about 544 ME data is written to page.sys while other files that users might want to protect are only about 16 MB. The third example runs Loadsim on Exchange Server with 20 users. The data written to log file is about 360 MB and database updated is about 333 ME. CFP is able to prevent all these temporary or useless files from wasting disk space. On the contrary, block level CDP will store all these data in versioning data because it is not aware of file information. Provided that CFP is designed for long term continuous file protection, it can save orders of magnitude storage space than block level CDP systems.

As discussed above, CFP makes use of a write-once log to organize CDP data. It tries to store old data for each write request in one write operation to reduce performance impact while avoiding space waste for disk address alignment. To see how much storage space is required to keep all the versions, we measure the size of versioning data with the assumption that disaster recoverability is a basic requirement for both CFP and XOSoft.

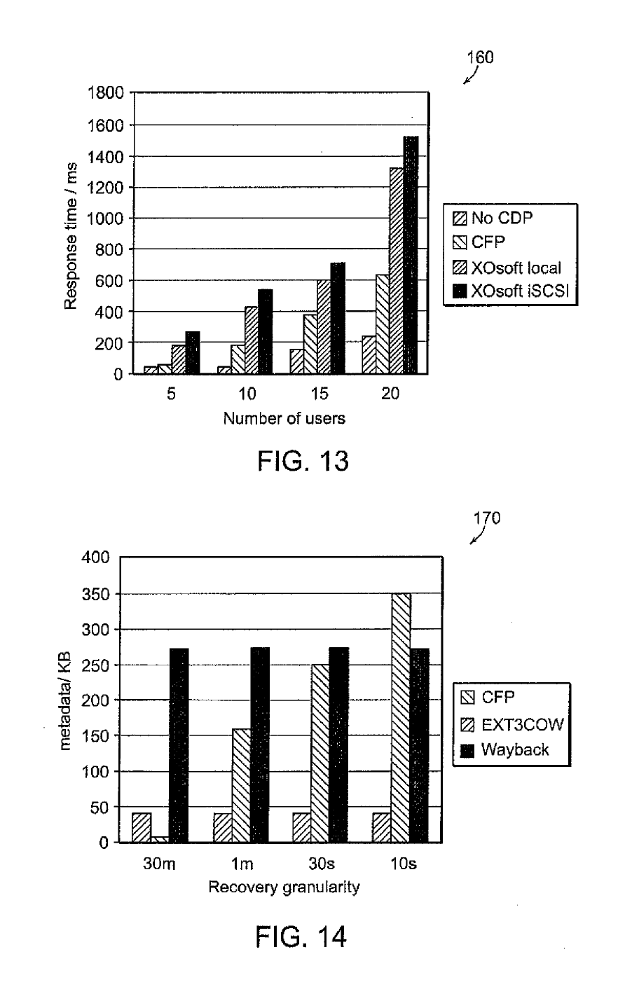

FIG. 15 shows at 180 the space overheads of CFP and XOSoft as a function of accumulated write sizes ranging from 200 MB to 302 GB of Iometer with request size of 8 KB. It is observed that CFP uses about the same amount of storage space to save versioning data as XOSoft. Considering both CFP and XOSoft can provide file-oriented protection, they all provide better space efficiency than traditional block-level CDP systems because useless temporary files can be excluded.

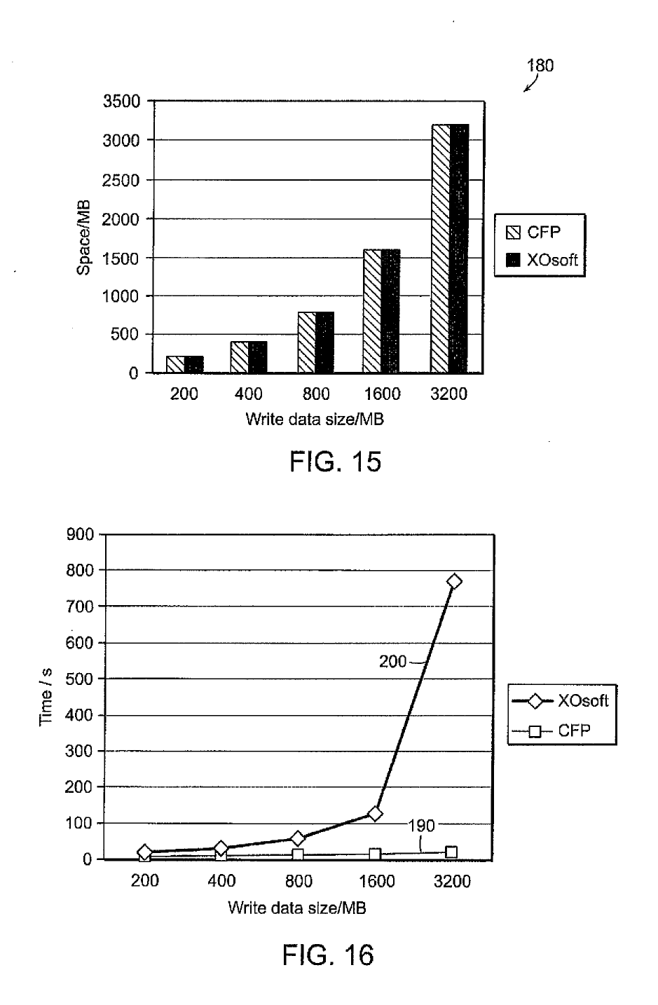

An important feature of data protection solutions is providing fast data recovery. We now measure the RTO of the CFP as compared to XOSoft. We run lometer with sequential 100% write of 8 KB requests and watch the written data size grow from task manager. The lometer is stopped when certain amount of data has been written. Then we measure the recovery time using CFP or XOSoft. FIG. 16 shows the recovery time of CFP and XOSoft as a function of amount of data written.

In particular, FIG. 16 shows at 190 that the recovery time of CFP is significantly lower than that of XOSoft as shown at 200. This fast data recovery of CPF comes from our effective design of the versioning table. At data recovery time, CFP builds a version table and mounts the volume of data at previous time points as a separate volume on the host. Users can view all the files and select what files to recover before recovery. Users can also move the time point back and forward to find the best time point to recover data. The recovery time of CFP is the sum of the time to build versioning table and the time to copy files. The copying time is fixed and the time to build versioning table increases as CDP data increases. However, the size of metadata to build versioning table is much less than actual data to be recovered. Furthermore, the copying time can be reduced using some file synchronization tool. XOSoft, on the other hands, needs to rewind the journal log to get the file at specified time point, which is time consuming. That is why its recovery time increases as the versioning data size increases. The recovery time of XOSoft includes rewinding time to find the recovery point and data recovery time. It is shown in FIG. 16 that the recovery time of CFP is orders of magnitude lower than that of XOSoft when versioning data size is large. CFP's recovery time does not increase significantly with versioning data size achieving almost constant recovery time. The recovery time of XOSoft is the same as CFP at the beginning because the Iometer test file is about 500 MB so that the time to copy file is about the same as rewinding versioning data.

Various embodiments of the present invention therefore, provide Continuous File Protection at block level, referred to as CFP. CFP possesses the advantages of both file system versioning and block level CDP. Compared to file system versioning systems, CFP is more metadata efficient because it uses compact metadata instead of file system Mode. More importantly, CFP achieves better performance than file system level CDP because it leverages a thin driver that only forwards selected write requests to storage server. Compared to block level CDP, CFP provides higher space efficiency because it is able to exclude useless data from versioning storage. Furthermore, CFP allows users to select files or folders to protect and to recover as opposed to entire volumes in block level CDP. A prototype of CFP has been implemented using file system filter driver and iSCSI target. Standard benchmarks such as Iometer (operated by the Open Source Development Lab), Postmark (owned by Network Appliance, Inc. of Sunnyvale, Calif.), and LoadSim (owned by Microsoft Corporation of Redmond Wash.) have been used to evaluate CFP as compared with existing systems. Experiments have demonstrated speed advantages of CFP over existing file versioning systems and a commercial CDP product, and recovery experimental results show that the recovery time of CFP is orders of magnitude lower than existing commercial products.

Those skilled in the art will appreciate that numerous modifications and variations may be made to the above disclosed embodiments without departing from the spirit and scope of the invention.

What is claimed is:

1. A system for providing continuous file protection in a computer processing system, said system comprising:
a configuration module that permits a user to elect certain files or folders for protection, wherein said configuration module runs at an application layer without involving the computer processing system's operating system;
a filter driver that intercepts and splits write inputs and outputs addressed at protected files or folders; and
a storage module that is run without involving the computer processing system's operating system, said storage module for performing functions including data logging, version managements, and data recovery.

2. The system as claimed in claim 1, wherein creation, maintenance and recovery of versions of data are all done a block level.

3. The system as claimed in claim 1, wherein said filter driver splits and mirrors all write inputs and outputs.

4. The system as claimed in claim 1, wherein said storage module is implemented as an iSCSI target.

5. The system as claimed in claim 1, wherein said filter driver includes a kernel module that interprets write requests based on the file name of each request.

6. The system as claimed in claim 5, wherein said kernel module includes a whitelist of files and folders to be protected, and a blacklist of files and folders that do not need to be protected.

7. The system as claimed in claim 6, wherein said filter driver includes a string matching algorithm that processes the whitelist of files and the blacklist of files.

8. The system as claimed in claim 1, wherein said filter includes a Bloom filter.

9. The system as claimed in claim 1, wherein said storage module includes a write-once log.

10. The system as claimed in claim 1, wherein said storage module includes a hash table.

11. A method of providing continuous file protection in a computer processing system, said method comprising the steps of:
providing a configuration module that permits a user to elect certain files or folders for protection, wherein said configuration module runs at an application layer without involving the computer processing system's operating system;
intercepting and splitting write inputs and outputs addressed at protected files or folders with a filter driver; and
performing functions including data logging, version managements, and data recovery using a storage module that is run without involving the computer processing system's operating system.

12. The method as claimed in claim 11, wherein creation, maintenance and recovery of versions of data are all done a block level.

13. The method as claimed in claim 11, wherein said filter driver splits and mirrors all write inputs and outputs.

14. The method as claimed in claim 11, wherein said storage module is implemented as an iSCSI target.

15. The method as claimed in claim 11, wherein said filter driver includes a kernel module that interprets write requests based on the file name of each request.

16. The method as claimed in claim 15, wherein said kernel module includes a whitelist of files and folders to be protected, and a blacklist of files and folders that do not need to be protected.

17. The method as claimed in claim 16, wherein said filter driver includes a string matching algorithm that processes the whitelist of files and the blacklist of files.

18. The method as claimed in claim 11, wherein said filter includes a Bloom filter.

19. The method as claimed in claim 11, wherein said storage module includes a write-once log.

20. The method as claimed in claim 11, wherein said storage module includes a hash table.
